(19) United States
(12) Patent Application Publication
(10) Pub. No.: US 2026/0289353 A1
(43) Pub. Date: Sep. 24, 2026

(54) INFORMATION PROCESSING DEVICE, MODEL GENERATION METHOD, AND RECORDING MEDIUM

(71) Applicant: NEC CORPORATION, Tokyo (JP)

(72) Inventors: Katsuya HAYAMI, Tokyo (JP); Masaki KOIZUMI, Tokyo (JP); Kenta KASAHARA, Tokyo (JP)

(73) Assignee: NEC CORPORATION, Tokyo (JP)

(21) Appl. No.: 19/490,092

(22) PCT Filed: Jun. 30, 2023
(86) PCT No.: PCT/JP2023/024313

§ 371 Date: Dec. 4, 2025

(51) Int. Cl. G06N 5/04

(52) U.S. Cl. CPC G06N 5/041

(57) ABSTRACT

An information processing device for generating a hypothesis model for covariance structure analysis, the device includes, one or more processors and a memory storing instructions executable by the processors, the instructions causing the processors to, perform a causal discovery process on data representing a plurality of observation variables to infer relationships among a plurality of elements including at least one latent factor associated with the observation variables, and generate, based on the inferred relationships, a hypothesis model for covariance structure analysis from the plurality of elements, the hypothesis model being represented as a directed graph structure including nodes corresponding to the observation variables and the at least one latent factor, and edges parameterized by path coefficients.

### TECHNICAL FIELD

The present invention relates to an information processing device or the like that assists covariance structure analysis.

### BACKGROUND ART An analysis method called covariance structure analysis has been conventionally known. The covariance structure analysis is a type of multivariate analysis which is also called Structural Equation Modeling (SEM). In the covariance structure analysis, by analyzing a structure of a covariance between observation variables that are variables obtained by experiments or observations, a latent factor that cannot be directly observed is introduced, and a structure of a causal relationship including the latent factor is analyzed.

More specifically, in the covariance structure analysis, a hypothesis model indicating a relationship between a plurality of elements including the latent factor is generated, and the generated hypothesis model is statistically evaluated and verified, in such a way as to analyze a relationship between the elements. Although the covariance structure analysis is a useful analysis method, the covariance structure analysis cannot be easily performed by anyone, and therefore, a technology for assisting the covariance structure analysis has been developed. For example, PTL 1 below discloses a creation assistance system that extracts a structure of a model using an accumulated model and makes it possible to improve a prediction model using the extracted structure.

### CITATION LIST

### Patent Literature

PTL 1: JP 2009-266158 A

### SUMMARY OF INVENTION

### Technical Problem

A creation assistance system described in PTL 1 has a problem in that it is necessary to create a prediction model (related to hypothesis model described above) by an operator's operation and the generation of the model is not easy. One aspect of the present invention has been made in view of such a problem, and an example of objects is to provide a technology that enables to easily generate a hypothesis model for covariance structure analysis.

### Solution to Problem

An information processing device according to one aspect of the present invention includes inference means for inferring a relationship between a plurality of elements including a latent factor associated with a plurality of observation variables by causal discovery and model generation means for generating a hypothesis model for covariance structure analysis from the plurality of elements, based on a result of the inference.

A model generation method according to one aspect of the present invention, performed by at least one processor, the method includes inferring a relationship between a plurality of elements including a latent factor associated with a plurality of observation variables by causal discovery and generating a hypothesis model for covariance structure analysis from the plurality of elements, based on a result of the inference.

A model generation program according to one aspect of the present invention for causing a computer to function as inference means for inferring a relationship between a plurality of elements including a latent factor associated with a plurality of observation variables by causal discovery and model generation means for generating a hypothesis model for covariance structure analysis from the plurality of elements, based on a result of the inference.

### ADVANTAGEOUS EFFECTS OF INVENTION

According to one aspect of the present invention, it is possible to easily generate a hypothesis model for covariance structure analysis.

### BRIEF DESCRIPTION OF DRAWINGS

FIG. 1 is a block diagram illustrating a configuration of an information processing device according to a first example embodiment of the present invention.

FIG. 2 is a flowchart illustrating a flow of a model generation method according to the first example embodiment of the present invention.

FIG. 3 is a diagram illustrating an example of a hypothesis model generated by a model generation method according to a second example embodiment of the present invention.

FIG. 4 is a block diagram illustrating a configuration of an information processing device according to the second example embodiment of the present invention.

FIG. 5 is a diagram illustrating an example of a latent factor setting screen.

FIG. 6 is a diagram illustrating an example of a hierarchized hypothesis model.

FIG. 7 is a diagram illustrating a display example of the hypothesis model.

FIG. 8 is a flowchart illustrating a flow of the model generation method according to the second example embodiment of the present invention.

FIG. 9 is a diagram for explaining an example of displaying a causal graph and causing an operator to set a latent variable.

FIG. 10 is a diagram illustrating an example of a computer that executes a command of a program that is software for achieving each function of each device according to each example embodiment of the present invention.

### EXAMPLE EMBODIMENT

### First Example Embodiment

A first example embodiment of the present invention will be described in detail with reference to the drawings. The present example embodiment is a basic form of example embodiments to be described later.

### Configuration of Information Processing Device

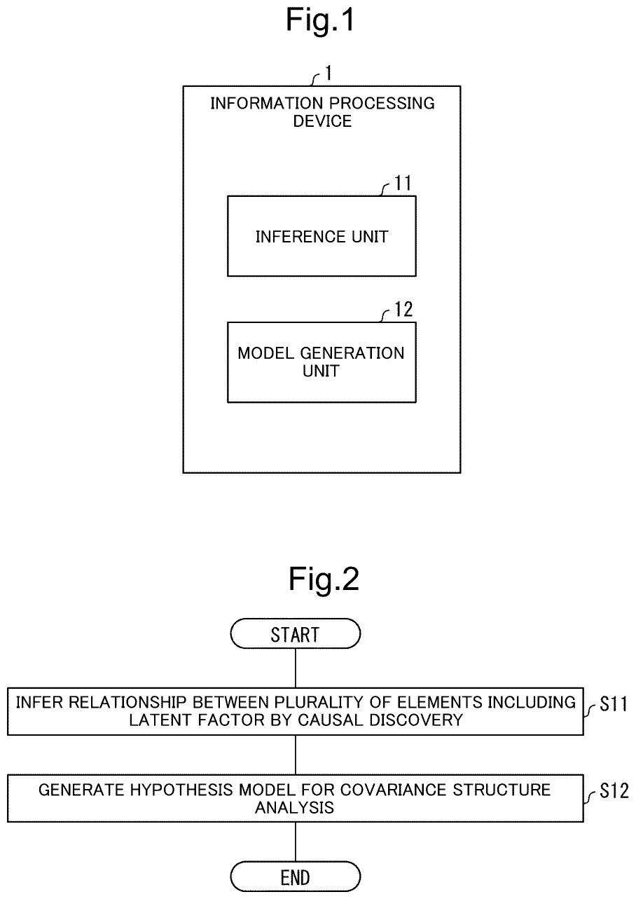

A configuration of an information processing device 1 according to the present example embodiment will be described with reference to FIG. 1. FIG. 1 is a block diagram illustrating the configuration of the information processing device 1. As illustrated, the information processing device 1 includes an inference unit 11 and a model generation unit 12.

The inference unit 11 infers a relationship between a plurality of elements including a latent factor associated with a plurality of observation variables by causal discovery.

The model generation unit 12 generates a hypothesis model for covariance structure analysis from the plurality of elements, based on a result of the inference by the inference unit 11.

As described above, the information processing device 1 according to the present example embodiment includes the inference unit 11 that infers the relationship between the plurality of elements including the latent factor associated with the plurality of observation variables by causal discovery and the model generation unit 12 that generates the hypothesis model for covariance structure analysis from the plurality of elements, based on the result of the inference. Therefore, according to the information processing device 1 according to the present example embodiment, an effect can be obtained that it is possible to easily generate the hypothesis model for covariance structure analysis.

### Model Generation Program

Functions of the information processing device 1 can be achieved by a program. A model generation program according to the present example embodiment adopts a configuration in which a computer is caused to function as inference means for inferring the relationship between the plurality of elements including the latent factor associated with the plurality of observation variables by causal discovery and model generation means for generating the hypothesis model for covariance structure analysis from the plurality of elements, based on the result of the inference. Therefore, according to the model generation program according to the present example embodiment, an effect can be obtained that it is possible to easily generate the hypothesis model for covariance structure analysis.

### Flow of Model Generation Method

A flow of a model generation method according to the present example embodiment will be described with reference to FIG. 2. FIG. 2 is a flowchart illustrating the flow of the model generation method. An execution entity of each step in the model generation method may be a processor included in the information processing device 1 or a processor included in another device, and the execution entities of the respective steps may be processors provided in different devices.

In S11, at least one processor infers a relationship between a plurality of elements including a latent factor associated with a plurality of observation variables by causal discovery.

In S12, at least one processor generates a hypothesis model for covariance structure analysis from the plurality of elements, based on a result of the inference in S11.

As described above, the model generation method according to the present example embodiment includes, by at least one processor, inferring the relationship between the plurality of elements including the latent factor associated with the plurality of observation variables by causal discovery and generating the hypothesis model for covariance structure analysis from the plurality of elements, based on the result of the inference. Therefore, according to the model generation method according to the present example embodiment, an effect can be obtained that it is possible to easily generate the hypothesis model for covariance structure analysis.

### Second Example Embodiment

### Outline of Model Generation Method

According to a model generation method according to the present example embodiment (hereinafter, referred to as the present method), it is possible to easily generate a hypothesis model for covariance structure analysis. As described in “Background Art”, conventionally, the hypothesis model has been manually generated, and it has not been easy to generate an appropriate hypothesis model. In this regard, since it is possible to easily generate the hypothesis model according to the present method, it is possible to easily perform covariance structure analysis by using the present method.

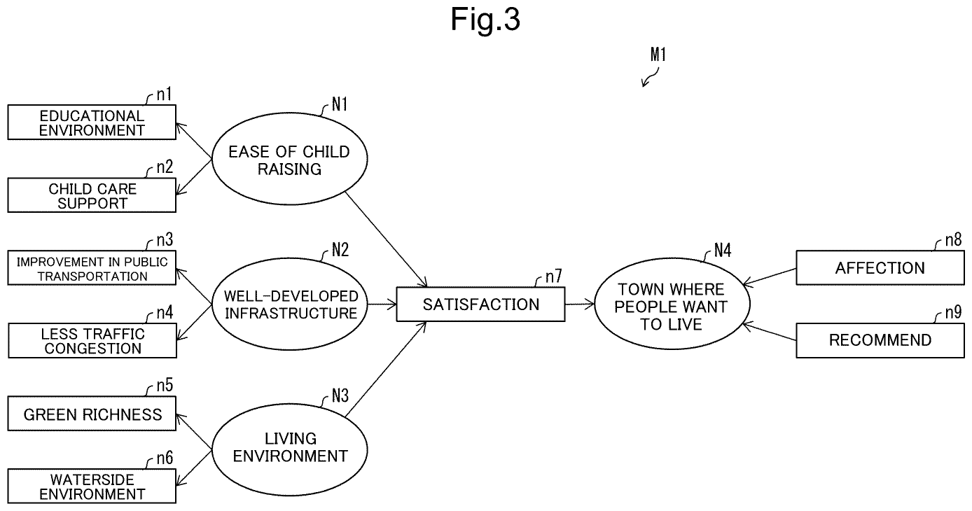

An outline of the present method will be described with reference to FIG. 3. FIG. 3 is a diagram illustrating an example of the hypothesis model generated by the present method. A hypothesis model M1 illustrated in FIG. 3 represents a relationship between a plurality of elements including observation variables and latent factors (also can be referred to as latent variable) as nodes and paths.

Specifically, the hypothesis model MI includes rectangular nodes n1 to n9 indicating the observation variables and elliptical nodes N1 to N4 indicating the latent factors, and a relationship between these nodes is represented by an arrow connecting between the nodes, that is, the path.

For example, a path starting from the node N1 and ending at the node n1 is illustrated between the node N1 of the latent factor and the node n1 of the observation variable, and this path indicates that the node N1 explains the node n1. A name indicating the observation variable or the latent factor related to each node is described in each node. For example, “educational environment” described in the node n1 indicates a name given to the observation variable of the node n1. The observation variable of the node n1 is a variable related to the “educational environment”.

According to the present method, the relationship between the plurality of elements including the latent factor is inferred by causal discovery. This is equivalent to inferring what path is established between the nodes. For example, an inference result indicating that the node N1 and the node n7 have a relationship in which the node N1 explains the node n7 means that a path starting from the node N1 and ending at the node n7 is established. As a result, the hypothesis model M1 for covariance structure analysis as illustrated in FIG. 3 can be automatically generated.

Then, an operator can analyze a relevance between the elements from the generated hypothesis model M1. For example, in the example in FIG. 3, in order to make a certain city be “a town where people want to live”, it is possible to analyze that measures for improving “ease of child raising”, “well-developed infrastructure”, and “living environment” and enhancing “a satisfaction level” of residents are effective.

The present method can be used for data analysis in the medical field or the healthcare field. For example, an inference unit 205 may infer a relationship between a plurality of elements including a latent factor associated with an observation variable regarding a subject who desires to maintain or improve a health state, by causal discovery. Then, a model generation unit 206 may generate the hypothesis model for covariance structure analysis from the plurality of elements, based on the result of the inference by the inference unit 205.

As a specific example, for a plurality of subjects, the inference unit 205 may infer a relationship between a plurality of elements including a latent factor associated with an observation variable indicating various inspection results, lifestyle habits, or the like (for example, lack of exercise, unbalanced nutrition, or the like), by causal discovery. A user of an information processing device 1 can analyze effective measures for maintaining or improving the health state of the user, by referring to the hypothesis model generated based on the result of such inference.

### Configuration of Information Processing Device

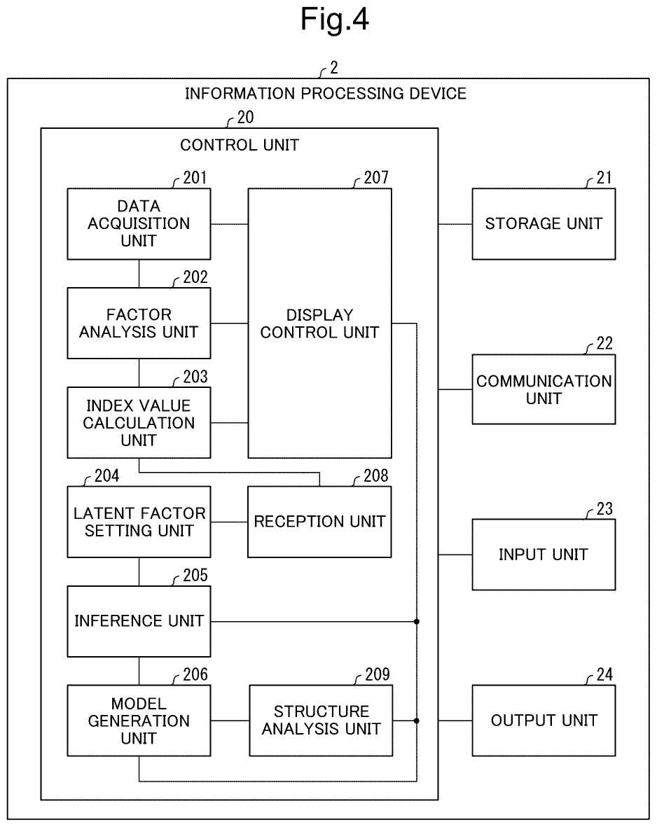

A configuration of an information processing device 2 according to the present example embodiment will be described with reference to FIG. 4. FIG. 4 is a block diagram illustrating the configuration of the information processing device 2. The information processing device 2 is a device that has a function for generating a hypothesis model for covariance structure analysis. The information processing device 2 may be a device of which a main function is to generate the hypothesis model or may be a general-purpose device that has other functions.

As illustrated, the information processing device 2 includes a control unit 20 that integrally controls each unit of the information processing device 2 and a storage unit 21 that stores various types of data used by the information processing device 2. The information processing device 2 includes a communication unit 22 that allows the information processing device 2 to communicate with other devices, an input unit 23 that receives input of various types of data for the information processing device 2, and an output unit 24 that allows the information processing device 2 to output various types of data. Each configuration from the storage unit 21 to the output unit 24 may be built in the information processing device 2 or may be an external device of the information processing device 2 externally attached to the information processing device 2.

As illustrated, the control unit 20 of the information processing device 2 includes a data acquisition unit 201, a factor analysis unit 202, an index value calculation unit 203, a latent factor setting unit 204, the inference unit 205, the model generation unit 206, a display control unit 207, a reception unit 208, and a structure analysis unit 209.

The data acquisition unit 201 acquires various types of data used for covariance structure analysis.

For example, the data acquisition unit 201 acquires the observation variable used for covariance structure analysis. A data acquisition method is not particularly limited. For example, the data acquisition unit 201 may acquire data input by the operator of the information processing device 2 via the input unit 23 or may acquire data from another device by communication via the communication unit 22.

The factor analysis unit 202 classifies the plurality of observation variables into a plurality of groups by exploratory factor analysis. The exploratory factor analysis is an analysis method for estimating what factor brings a correlation between the plurality of observation variables, based on a correlation coefficient between the observation variables. That is, the group relates to the factor that brings the correlation between the observation variables included in the group, that is, the latent factor. In other words, the factor analysis unit 202 groups the plurality of observation variables for each latent factor associated with the observation variables. The number of groups to be classified (in other words, how many latent factors are set) may be determined in advance or may be designated by the operator.

The index value calculation unit 203 calculates an index value indicating appropriateness of associating these observation variables with the single latent factor, for the grouped observation variables. An index value calculation method is not particularly limited. For example, the index value calculation unit 203 may calculate a Cronbach's alpha value, as the index value. The index value calculation unit 203 may calculate a factor loading representing a magnitude of an influence on each variable from the factor, as the index value. Such an index value functions as reference information when the operator determines a name of the latent factor.

The latent factor setting unit 204 sets the latent factor in covariance structure analysis. The latent factor may be automatically or manually set. In a case of automatic setting, the latent factor setting unit 204 sets a latent factor related to the group, for each group into which the factor analysis unit 202 has classified the observation variable. On the other hand, in a case of manual setting, the latent factor setting unit 204 sets a latent factor related to the group, for each group of the observation variables designated by the operator. After the factor analysis unit 202 classifies the observation variables into the plurality of groups, the display control unit 207 may display each group as a latent factor candidate and enable the operator to change the observation variable belonging to each group. In this case, the latent factor setting unit 204 sets the latent factor related to each changed group.

The inference unit 205 infers a relationship between a plurality of elements including a latent factor associated with a plurality of observation variables by causal discovery. The latent factor is set by the latent factor setting unit 204. An element to be a target of causal discovery may include the latent factor set by the latent factor setting unit 204, each observation variable acquired by the data acquisition unit 201, a synthesis variable generated from the observation variable, or the like.

The causal discovery is a method for inferring what kind of causal relationship exists between the elements (or no causal relationship), from each element. As a specific method of causal discovery, for example, a method using a structural equation model or the like has been known, and the inference unit 205 may perform the above inference by applying such a method.

The model generation unit 206 generates the hypothesis model for covariance structure analysis from the plurality of elements, based on the result of the inference by the inference unit 205. The generated hypothesis model is a model indicating the result of the inference by the inference unit 205, that is, the relationship between the plurality of elements including the latent factor (what kind of causal relationship exists between what elements).

The display control unit 207 displays various types of information regarding covariance structure analysis on a display device. For example, the display control unit 207 displays each group into which the factor analysis unit 202 has classified the observation variables, as a latent factor candidate. The display control unit 207 displays the index value calculated by the index value calculation unit 203. The display device may be included in the information processing device 2 or may be an external device of the information processing device 2.

The reception unit 208 receives an input of the operator and executes processing according to the input. For example, in a case where the latent factor is manually set, the reception unit 208 receives designation by the operator and classifies the observation variables into the plurality of groups according to the designation.

The structure analysis unit 209 performs structure analysis on the hypothesis model generated by the model generation unit 206 and calculates an index value indicating a fitting degree of the hypothesis model. An index value calculation method is not particularly limited.

For example, the structure analysis unit 209 may calculate at least one of values of Root Mean Square Error of Approximation (RMSEA), Goodness of Fit Index (GFI), Comparative Fit Index (CFI), and Akaike's Information Criterion (AIC), as the index value. The structure analysis unit 209 calculates a path coefficient between elements having a causal relationship, in the hypothesis model generated by the model generation unit 206. The path coefficient is a coefficient calculated using a weight value of the path connecting each element. The weight value can be calculated by a known causal inference method. The calculation of the index value and the calculation of the path coefficient may be performed in different processing blocks.

As described above, the information processing device 2 according to the present example embodiment includes the inference unit 205 that infers the relationship between the plurality of elements including the latent factor associated with the plurality of observation variables by causal discovery and the model generation unit 206 that generates the hypothesis model for covariance structure analysis from the plurality of elements, based on the result of the inference by the inference unit 205. Therefore, according to the information processing device 2 according to the present example embodiment, an effect can be obtained that it is possible to easily generate the hypothesis model for covariance structure analysis. The hypothesis model generated by the information processing device 1 is useful for user's decision making or the like. That is, according to the information processing device 1, it is possible to facilitate user's decision making.

The information processing device 2 according to the present example embodiment adopts a configuration including the factor analysis unit 202 that classifies the plurality of observation variables into the plurality of groups by exploratory factor analysis and the display control unit 207 that displays each group as the latent factor candidate. Therefore, according to the information processing device 2 according to the present example embodiment, in addition to the effect achieved by the information processing device 1 according to the first example embodiment, an effect can be obtained that it is possible to easily set the latent factor.

In the information processing device 2 according to the present example embodiment, a configuration is adopted including the reception unit 208 that receives the designation by the operator and classifies the plurality of observation variables into the plurality of groups according to the designation, the index value calculation unit 203 that calculates the index value indicating the appropriateness of setting the latent factor related to the group, for each group, and the display control unit 207 that displays the index value. Therefore, according to the information processing device 2 according to the present example embodiment, in addition to the effect achieved by the information processing device 1 according to the first example embodiment, an effect can be obtained that it is possible to set an appropriate latent factor, while reflecting a subjective view of the operator.

### Example of Latent Factor Setting Screen

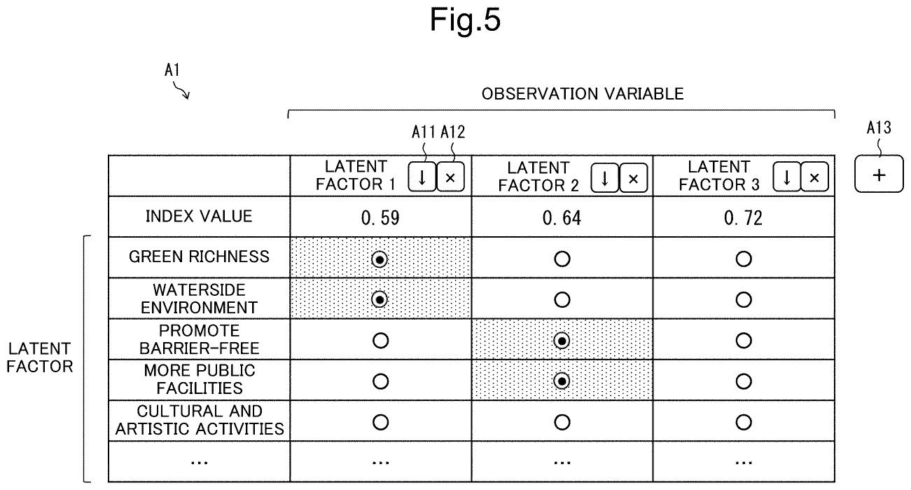

In a case where the information processing device 2 assists covariance structure analysis, when the latent factor is set, for example, a setting screen illustrated in FIG. 5 may be displayed, and an input of the operator may be received. FIG. 5 is a diagram illustrating an example of a latent factor setting screen.

A setting screen A1 illustrated in FIG. 5 represents a relationship between the plurality of observation variables and the latent factors associated with the respective observation variables in a table format.

More specifically, in the setting screen A1, the observation variable is illustrated in each row below a row of the “index value”, the latent factor is illustrated in each of a plurality of columns, and a check box is displayed at a position where the row and the column intersect with each other.

The check box being checked indicates that the observation variable in the row is associated with the latent factor in the column. For example, in a row of “green richness” and a row of “waterside environment” which are the observation variables, check boxes at positions intersecting with a column of a “latent factor 1” are checked.

This indicates that these observation variables are associated with the single latent factor “latent factor 1”.

In the setting screen A1, in a column of each latent factor, the index value calculated by the index value calculation unit 203 is displayed, and an object A11 used to rearrange the observation variables in the column and an object A12 used to delete the column are displayed. An object A13 used to add a new latent factor is also displayed.

When the reception unit 208 receives an input of the operator for the object A11, the display control unit 207 rearranges the rows of the observation variables in such a way that the observation variables are arranged in order from the observation variable of which the check box is checked, in the column related to the object A11. When the reception unit 208 receives an input of the operator for the object A12, the display control unit 207 deletes a column related to the object A12. Then, when the reception unit 208 receives an input of the operator for the object A13, the display control unit 207 displays a column related to a new latent variable.

The setting screen A1 can be generated based on a classification result of the observation variable by the factor analysis unit 202. In this case, it is sufficient for the operator to input an observation variable to be used into the information processing device 2 and designate the number of latent factors, that is, the number of groups into which the observation variables are classified as three. As a result, since the factor analysis unit 202 classifies the observation variables into three groups, it is sufficient for the display control unit 207 to generate the setting screen A1 according to the classification result and display the setting screen A1. For each group of the observation variable defined by the factor analysis unit 202, the index value calculation unit 203 calculates the index value indicating the appropriateness of associating these observation variables with the single latent factor, and the display control unit 207 displays the calculated index value in the row of the “index value”. For example, the index value may be a Cronbach's alpha value.

Here, the reception unit 208 may receive a change in the observation variable associated with the latent factor, in the setting screen A1. For example, when an operation for selecting an already checked check box is performed, the display control unit 207 may uncheck the check box, and the reception unit 208 may release association between an observation variable related to the check box and a latent factor related to the check box. When an operation for selecting an unchecked check box is performed, the display control unit 207 may check the check box, and the reception unit 208 may associate an observation variable related to the check box with a latent factor related to the check box.

In a case where grouping of the observation variables by the factor analysis unit 202 is not performed, the display control unit 207 may display the setting screen A1 in a state where no check box is checked. In this case, it is sufficient for the operator to determine observation variables to be associated with the latent factor, for each latent factor, and perform an operation for checking a check box related to these observation variables. Then, the index value calculation unit 203 calculates the index value indicating the appropriateness of associating these observation variables with the single latent factor, and the display control unit 207 displays the calculated index value.

When what latent factor is associated with each observation variable is determined as described above, the latent factor setting unit 204 sets each determined latent factor as the latent factor in covariance structure analysis. At this time, the reception unit 208 may receive an input of a name of each latent factor, and in this case, the latent factor setting unit 204 records the input name in the storage unit 21 or the like together with the observation variable associated with the latent factor.

The display control unit 207 may display the input name on the setting screen A1 (for example, display input name instead of “latent factor 1” to “latent factor 3”).

### Generation of Hierarchized Hypothesis Model

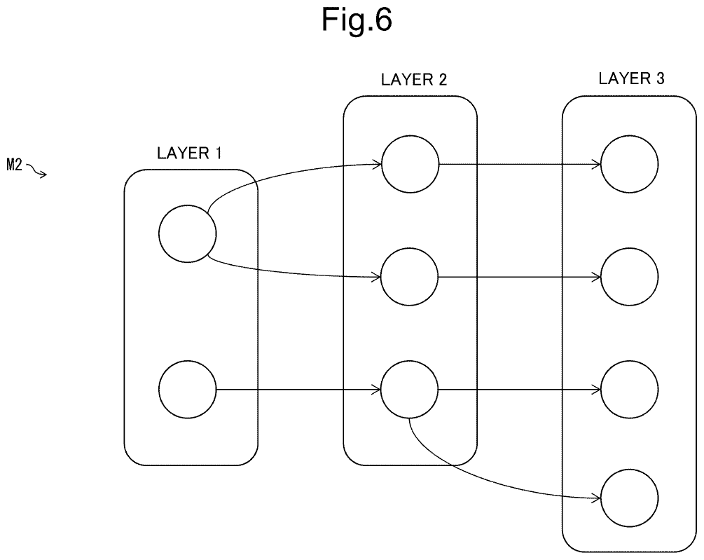

The information processing device 2 can also generate a hierarchized hypothesis model. This will be described with reference to FIG. 6. FIG. 6 is a diagram illustrating an example of the hierarchized hypothesis model. In FIG. 6, both of a node of an observation variable and a node of a latent factor are illustrated as circular objects without distinguishing the nodes from each other.

A hypothesis model M2 illustrated in FIG. 6 represents a relationship between nine nodes by a path connecting these nodes. These nine nodes are hierarchized into three layers including “a layer 1”, “a layer 2”, and “a layer 3”.

In a case where such a hypothesis model M2 is generated, for each element to be a target of covariance structure analysis, it is sufficient to give hierarchy information indicating a layer to which the element belongs, in advance. Then, if the inference unit 205 performs causal discovery using the hierarchy information as a constraint condition, the model generation unit 206 can generate the hypothesis model hierarchized in layer units indicated in the hierarchy information.

Specifically, it is sufficient for the inference unit 205 to infer a relationship between elements in different layers indicated in the hierarchy information by causal discovery. As a result, since the relationship between the elements belonging to the same layer is not inferred, it is possible to generate the hypothesis model hierarchized in layer units indicated in the hierarchy information. The inference unit 205 may infer a relationship between elements in adjacent layers indicated in the hierarchy information by causal discovery. As a result, it is possible to generate the hierarchized hypothesis model according to an order of the layers indicated in the hierarchy information.

As described above, the hierarchy information indicating the layer to which each element belongs may be given to each of the plurality of elements to be the target of covariance structure analysis. In this case, the inference unit 205 may infer the relationship between the elements in the different layers indicated in the hierarchy information by causal discovery, and the model generation unit 206 may generate the hypothesis model hierarchized in layer units indicated in the hierarchy information.

As a result, in addition to the effect achieved by the information processing device 1 according to the first example embodiment, and an effect can be obtained that the hierarchized hypothesis model can be automatically generated.

The hierarchized hypothesis model is useful, for example, for analysis related to manufacturing management of a product or the like. For example, an observation variable may be collected for each manufacturing process of the product, and hierarchy information indicating the manufacturing process may be associated with each observation variable. As a result, it is possible to generate a hypothesis model that can easily recognize a relationship between the observation variable in each manufacturing process and a latent factor associated with the observation variable and an observation variable and a latent factor in another manufacturing process.

### Regarding Display Mode of Hypothesis Model

As described above, the operator who performs covariance structure analysis using the information processing device 2 analyzes a relevance between the elements from the generated hypothesis model.

At this time, if the number of elements to be analyzed is large, the generated hypothesis model is complicated, and it is assumed that the analysis of the relevance between the elements be not smoothly proceeded.

Therefore, even in a case where the number of elements to be analyzed is large, it is preferable for the information processing device 2 to display a hypothesis model in a display mode in which the analysis of the relevance between the elements can smoothly proceed.

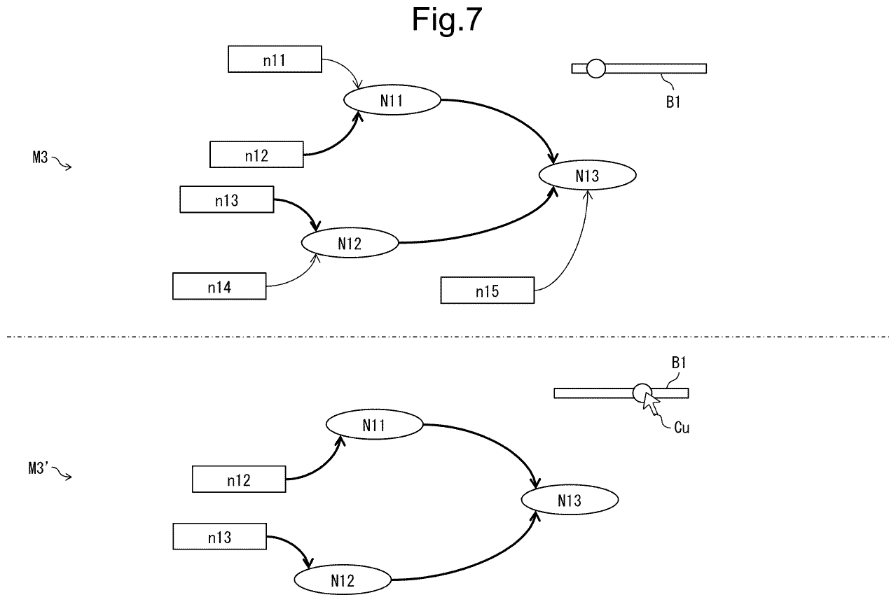

For example, the information processing device 2 may display the hypothesis model in a display mode as illustrated in FIG. 7. FIG. 7 is a diagram illustrating a display example of the hypothesis model. In FIG. 7, a hypothesis model M3 generated by the model generation unit 206 is illustrated. The hypothesis model M3 is a graph representing a relationship between nodes n11 to n15 of the observation variables and nodes N11 to N13 of the latent factors by paths.

In the hypothesis model M3, the path connecting between the nodes is displayed by a line having a thickness according to the path coefficient calculated by the structure analysis unit 209 or the like. In this way, the display control unit 207 may display the path in a display mode according to the path coefficient. As a result, it is possible to cause the operator to recognize a more influential path and to smoothly analyze the relevance between the elements.

In the example in FIG. 7, a path having a path coefficient equal to or more than a designated threshold and a node that is a starting point of the path are displayed, and a path having a path coefficient less than the threshold and a node that is a starting point of the path are not displayed. An object B1 illustrated in FIG. 7 is an object for designating this threshold, that is, an object for threshold designation.

The object B1 is an object in which a slider movable on a slider bar is arranged on the slider bar. The slider bar indicates a changeable range of the threshold of the path coefficient, and a position of the slider indicates the threshold of the path coefficient. The display control unit 207 displays such an object B1 in such a way that the operator can change the threshold of the path coefficient, by an intuitive and simple operation for moving the slider on the slider bar.

By decreasing the threshold by the object B1 for threshold designation, as illustrated on the upper side of FIG. 7, the operator can display all the nodes and paths included in the generated hypothesis model M3. By operating the object Bl for threshold designation with a cursor Cu and changing the threshold to a larger value, as illustrated on the lower side of FIG. 7, the operator can display a hypothesis model M3′ in which the path having the path coefficient less than the threshold and the node that is the starting point of the path are not displayed. The method for operating the object BI for threshold designation is not limited to the method using the cursor Cu.

As described above, the display control unit 207 may display the graph in which the hypothesis model is represented using the nodes and the paths and the object for threshold designation that receives the designation of the threshold of the path coefficient. Then, the display control unit 207 may display a path having a path coefficient equal to or more than a threshold designated by the object for threshold designation and a node that is a starting point of the path and does not need to display a path having a path coefficient less than the threshold and a node that is a starting point of the path. As a result, in addition to the effect achieved by the information processing device 1 according to the first example embodiment, an effect can be obtained that it is possible to easily perform analysis limited to the path having the path coefficient equal to or more than the designated threshold and the node connected by the path.

### Flow Of Model Generation Method

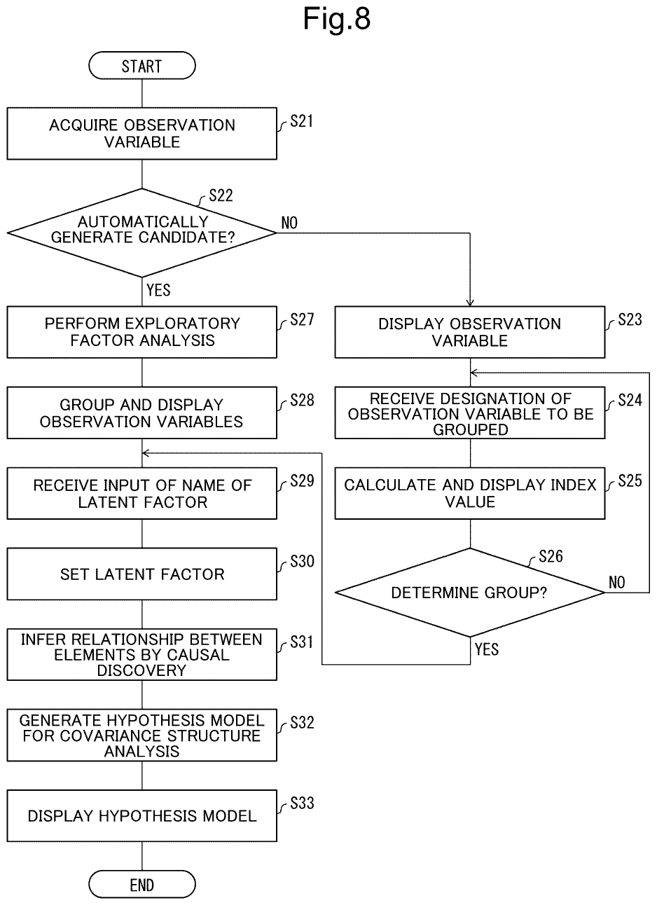

A flow of the model generation method according to the present example embodiment will be described with reference to FIG. 8. FIG. 8 is a flowchart illustrating the flow of the model generation method.

In S21, the data acquisition unit 201 acquires the plurality of observation variables used for covariance structure analysis. For example, the data acquisition unit 201 may acquire observation variables input by the operator via the input unit 23.

In S22, the factor analysis unit 202 determines whether the candidate of the latent factor is automatically generated. For example, the factor analysis unit 202 determines to automatically generate the candidate when the operator performs an input operation indicating that the candidate of the latent factor is automatically generated (YES in S22) and may determine not to automatically generate the candidate when the operator performs an input operation indicating that the candidate is manually generated (NO in S22). If YES is determined in S22, the processing proceeds to S27, and if NO is determined in S22, the processing proceeds to S23.

In S23, the display control unit 207 displays the observation variables acquired in S21 on the display device. In S24, the reception unit 208 receives designation of observation variables to be grouped, for the observation variables displayed by the processing in S23. For example, the display control unit 207 may present the observation variables to the operator by displaying the setting screen as illustrated in FIG. 5, and in this case, in S24, the reception unit 208 may receive the designation of the observation variable via the setting screen.

Then, in S25, the index value calculation unit 203 calculates the index value indicating the appropriateness of associating these observation variables with the single latent factor, for the observation variables grouped in S24, and the display control unit 207 displays the calculated index value. For example, as in the example in FIG. 5, the display control unit 207 may display the index value calculated for each latent factor, in association with the latent factor.

In S26, the latent factor setting unit 204 determines whether the group is determined. For example, the latent factor setting unit 204 may determine that the group is determined (YES in S26), when the observation variables to be included in the group are designated, for each of the number of groups designated by the operator, and then, an operation for determining the designation is performed. If NO is determined in S26, the processing returns to S24, and the reception unit 208 receives the designation (may be change) of the observation variable. On the other hand, if YES is determined in S26, the processing proceeds to S29.

In S27, the factor analysis unit 202 classifies the observation variables acquired in S21 into the plurality of groups, by exploratory factor analysis. Then, in S28, the display control unit 207 groups and displays the observation variables acquired in S21 into the plurality of groups, based on a classification result in S27. For example, the display control unit 207 may display the setting screen as in the example in FIG. 5. In this case, the index value may be calculated and displayed, as in S25. On this setting screen, the reception unit 208 may receive a change in the group of the observation variables (can be also referred to as observation variable associated with latent factor). In this case, the processing in and after S25 is executed on the changed group.

In S29, the reception unit 208 receives an input of a name of a latent factor related to the group, for each group of the observation variables. It is sufficient to execute the processing in S29 at any timing in or after S23 or S28.

In S30, the latent factor setting unit 204 sets each group to which the single or the plurality of observation variables belongs, as the latent factor in covariance structure analysis.

In S31, the inference unit 205 infers the relationship between the plurality of elements to be the target of covariance structure analysis by causal discovery. The plurality of elements includes the latent factor set in S30. The plurality of elements may include other elements such as an explanatory variable or the like input in S21.

In S32, the model generation unit 206 generates the hypothesis model for covariance structure analysis based on a result of the inference in S31. Then, in S33, the display control unit 207 displays the hypothesis model generated in S32, and then, ends the processing in FIG. 8.

After S32, the structure analysis unit 209 may perform structure analysis on the hypothesis model generated in S32 and calculate the index value indicating the fitting degree of the hypothesis model and the path coefficient of each path included in the hypothesis model. In this case, in S33, the display control unit 207 may display the calculated index value and path coefficient.

The reception unit 208 may receive correction by the operator of the hypothesis model. In a case where the hypothesis model is corrected, the structure analysis unit 209 calculates an index value indicating a fitting degree of the corrected hypothesis model and a path coefficient of each path included in the hypothesis model, and the display control unit 207 displays these.

As described above, the model generation method according to the present example embodiment includes inferring the relationship between the plurality of elements including the latent factor associated with the plurality of observation variables by causal discovery (S31) and generating the hypothesis model for covariance structure analysis from the plurality of elements to be the target of covariance structure analysis, based on the result of the inference (S32). Therefore, an effect can be obtained that it is possible to easily generate the hypothesis model for covariance structure analysis.

### Display of Causal Graph

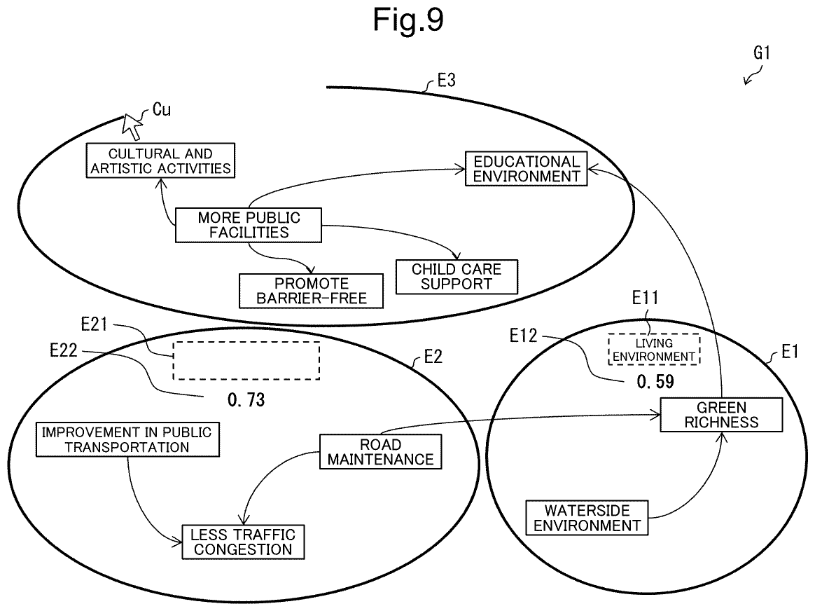

When causing the operator to set the latent variable, the information processing device 2 may display a causal graph indicating a causal relationship between observation variables. This will be described with reference to FIG. 9. FIG. 9 is a diagram for explaining an example of displaying a causal graph and causing an operator to set a latent variable.

The causal graph is a graph in which a plurality of elements subjected to causal analysis is represented by a node and a causal relationship between the elements is indicated by a directed edge (one-way arrow) and is also referred to as a directed acyclic graph. A causal graph G1 illustrated in FIG. 9 illustrates a causal relationship between observation variables such as “cultural and artistic activities” to be the target of covariance structure analysis, using the directed edges.

Such a causal graph can be generated by performing causal discovery by the inference unit 205 for an observation variable to be the target of covariance structure analysis.

In this way, the inference unit 205 can be used not only to generate the hypothesis model but also to generate the causal graph.

Since the causal graph illustrates the causal relationship between the observation variables, by displaying the causal graph, the operator can set the latent factor in consideration of the causal relationship between the observation variables. For example, in the example in FIG. 9, observation variables of “waterside environment” and “green richness” are connected by a causal relationship. After recognizing this point, the operator can group these observation variables. In the example in FIG. 9, a frame line E1 surrounding nodes of these observation variables indicates that these observation variables are grouped.

In the frame line E1, a name input field E11 where a name of a latent factor associated with the observation variables surrounded by the frame line E1 and an index value E12 calculated by the index value calculation unit 203 for the group of the observation variables indicated by the frame line E1 are displayed in association. In the name input field E11, a name “living environment” input by the operator is displayed.

Similarly, a frame line E2 illustrated in FIG. 9 indicates that three observation variables in total such as “improvement in public transportation” are grouped. Although a name input field E21 and an index value E22 are displayed in association in the frame line E2, as in the frame line E1, a name is not input into the name input field E21 yet.

When the operator selects the name input field E21 and inputs a desired name, a name of a latent factor related to the group of the frame line E2 is designated, and this name is displayed in the name input field E21.

In FIG. 9, an example is illustrated in which the observation variables are grouped by surrounding the observation variables by a drag operation using a mouse, and a trajectory of the drag operation is indicated by a curve E3. By enabling to group the observation variables by such an intuitive operation, it is possible for anyone to easily set the latent factor.

At a stage where the single or the plurality of observation variables is surrounded by the trajectory of the drag operation, the latent factor setting unit 204 may set a latent factor related to these observation variables. Then, the index value calculation unit 203 may calculate an index value for the latent factor, and the display control unit 207 may display the calculated index value.

It is preferable for the operator to easily change the group of the observation variables. For example, the reception unit 208 may receive an operation for moving the node of the observation variable from inside of the frame line indicating the group to outside as an operation for removing the observation variable from the group or may receive an operation for moving the node of the observation variable into the frame line indicating the group as an operation for adding the observation variable to the group. For example, the reception unit 208 may receive an operation for expanding or narrowing the frame line indicating the group. In this case, a node included in a frame line of which a shape or a size has been changed is a node belonging to a group related to the frame line.

Any grouping operation may be performed, and the grouping operation is not limited to the above example. It is not necessary to necessarily receive designation of the observation variables to be grouped, on the causal graph. For example, the display control unit 207 may display the causal graph and display the setting screen as illustrated in FIG. 5, and receive the designation of the observation variable to be grouped on the setting screen.

As described above, the display control unit 207 may display the causal graph indicating the causal relationship between the plurality of observation variables. Then, the reception unit 208 may receive the designation by the operator and classify the observation variables into the plurality of groups according to the designation, and the latent factor setting unit 204 may set the latent factor related to each group. As a result, in addition to the effect achieved by the information processing device 1 according to the first example embodiment, an effect can be obtained that the latent factor can be set in consideration of the causal relationship between the observation variables.

### Modified Example

An execution entity of each processing described in the above example embodiment is optional and is not limited to the above-described examples. That is, the functions of the information processing devices 1 and 2 can be achieved by a plurality of devices (can be referred to as processor) that can communicate with each other.

For example, each processing described in the flowcharts in FIGS. 2 and 8 can be shared and executed by the plurality of processors. That is, an execution entity of the model generation method in the example embodiments may be a single processor or a plurality of processors.

### Example of Achievement by Software

Some or all of the functions of the information processing device 1 or 2 may be achieved by hardware such as an integrated circuit (IC chip) or may be achieved by software.

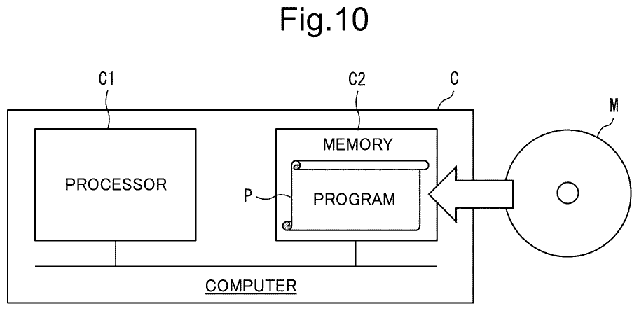

In the latter case, the information processing device 1 or 2 is achieved by, for example, a computer that executes a command of a program that is software for achieving each function. An example of such a computer (hereinafter, referred to as a computer C) is illustrated in FIG. 10. The computer C includes at least one processor C1 and at least one memory C2. A program (model generation program) P for causing the computer C to operate as the information processing device 1 or 2 is recorded in the memory C2. In the computer C, the processor C1 reads and executes the program P from the memory C2 to achieve each function of the information processing device 1 or 2.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination thereof, or the like can be used. As the memory C2, for example, a flash memory, a Hard Disk Drive (HDD), a Solid State Drive (SSD), or a combination thereof, or the like can be used.

The computer C may further include a Random Access Memory (RAM) for loading the program P at the time of execution and temporarily storing various types of data, for example. The computer C may further include a communication interface for sending and receiving data to and from another device. The computer C may further include an input/output interface for connecting input/output equipment such as a keyboard, a mouse, a display, or a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

### Supplementary Matter 1

The present invention is not limited to the above-described example embodiments, and various changes can be made without departing from the spirit and the scope as defined by the claims. For example, example embodiments obtained by appropriately combining the technical means disclosed in the above-described example embodiments are also included in the technical scope of the present invention.

### Supplementary Matter 2

Some or all the above-described example embodiments may be described as follows. However, the present invention is not limited to the following aspects.

### Supplementary Note 1

An information processing device including: inference means for inferring a relationship between a plurality of elements including a latent factor associated with a plurality of observation variables by causal discovery; and model generation means for generating a hypothesis model for covariance structure analysis from the plurality of elements, based on a result of the inference.

### Supplementary Note 2

The information processing device according to supplementary note 1, further including: factor analysis means for classifying the plurality of observation variables into a plurality of groups by exploratory factor analysis; and display control means for displaying each group as a candidate of a latent factor.

### Supplementary Note 3

The information processing device according to supplementary note 1 or 2, further including: reception means for receiving designation by an operator and classifying the plurality of observation variables into a plurality of groups according to the designation; index value calculation means for calculating an index value indicating appropriateness of setting a latent factor related to the group, for each group; and display control means for displaying the index value.

### Supplementary Note 4

The information processing device according to any one of supplementary notes 1 to 3, in which hierarchy information indicating a layer to which the element belongs is given to each of the plurality of elements, the inference means infers a relationship between elements in different layers indicated in the hierarchy information by causal discovery, and the model generation means generates the hypothesis model hierarchized in layer units indicated in the hierarchy information.

### Supplementary Note 5

The information processing device according to any one of supplementary notes 1 to 4, further including: display control means for displaying a graph representing the hypothesis model as a node and a path and an object for threshold designation that receives designation of a threshold of a path coefficient, in which the display control means displays a path having a path coefficient equal to or more than a threshold designated by the object for threshold designation and a node that is a starting point of the path and does not display a path having a path coefficient less than the threshold and a node that is a starting point of the path.

### Supplementary Note 6

The information processing device according to supplementary note 1, further including: display control means for displaying a causal graph indicating a causal relationship between the plurality of observation variables; reception means for receiving designation by an operator and classifying the observation variables into a plurality of groups according to the designation; and latent factor setting means for setting a latent factor related to each of the groups.

### Supplementary Note 7

A model generation method, performed by at least one processor, the method including: inferring a relationship between a plurality of elements including a latent factor associated with a plurality of observation variables by causal discovery; and generating a hypothesis model for covariance structure analysis from the plurality of elements, based on a result of the inference.

### Supplementary Note 8

A model generation program for causing a computer to function as: inference means for inferring a relationship between a plurality of elements including a latent factor associated with a plurality of observation variables by causal discovery; and model generation means for generating a hypothesis model for covariance structure analysis from the plurality of elements, based on a result of the inference.

### Supplementary Matter 3

Some or all of the above-described example embodiments may be further described as follows. An information processing device includes at least one processor, and the processor executes inference processing for inferring a relationship between a plurality of elements including a latent factor associated with a plurality of observation variables by causal discovery and model generation processing for generating a hypothesis model for covariance structure analysis from the plurality of elements, based on a result of the inference.

The information processing device may further include a memory, and the memory may store a model generation program for causing the processor to execute the inference processing and the model generation processing. This model generation program may be recorded in a non-transitory tangible computer-readable recording medium.

### REFERENCE SIGNS LIST

1 information processing device
11 inference unit (inference means)
12 model generation unit (model generation means)
2 information processing device
202 factor analysis unit (factor analysis means)
203 index value calculation unit (index value calculation means)
204 latent factor setting unit (latent factor setting means)
205 inference unit (inference means)
206 model generation unit (model generation means)
207 display control unit (display control means)
208 reception unit (reception means)

What is claimed is:

1. An information processing device for generating a hypothesis model for covariance structure analysis, the device comprising:
one or more processors and a memory storing instructions executable by the processors, the instructions causing the processors to:
perform a causal discovery process on data representing a plurality of observation variables to infer relationships among a plurality of elements including at least one latent factor associated with the observation variables; and
generate, based on the inferred relationships, a hypothesis model for covariance structure analysis from the plurality of elements, the hypothesis model being represented as a directed graph structure including nodes corresponding to the observation variables and the at least one latent factor, and edges parameterized by path coefficients.

2-8. (canceled)

9. The information processing device according to claim 1, wherein
the hypothesis model is stored in the memory as an adjacency matrix or a sparse matrix representation including a compressed sparse row (CSR) format, and
path coefficients are stored as floating-point arrays associated with respective edges.

10. The information processing device according to claim 1, wherein
the causal discovery process employs branch-and-prune based on conditional independence tests with a cap on a maximum parent-set size, and
further schedules exploration tasks with a parallel execution queue to reduce computational cost while preserving memory locality.

11. The information processing device according to claim 1, wherein
generating the hypothesis model includes retaining only edges whose confidence scores, computed via bootstrap or subsampling, meet a threshold, and applying regularization to covariance estimation (L2 or shrinkage) to improve numerical stability.

12. The information processing device according to claim 1, wherein
visualization of the hypothesis model performs
incremental updates that mask edges failing a threshold change,
minimizes node-coordinate recomputation via layout reuse, and
reduces redraw latency by limiting GPU buffer transfers to affected tiles using a tiled rendering scheme.

13. The information processing device according to claim 1,
wherein the at least one processor is further configured to execute the instructions to:
classify the plurality of observation variables into a plurality of groups by exploratory factor analysis; and
display each group as a candidate of a latent factor.

14. The information processing device according to claim 1,
wherein the at least one processor is further configured to execute the instructions to:
receive designation by an operator;
classify the plurality of observation variables into a plurality of groups according to the designation;
calculate an index value indicating appropriateness of setting a latent factor related to the group, for each group; and
display the index value.

15. The information processing device according to claim 1,
wherein the at least one processor is further configured to execute the instructions to:
infer a relationship between elements in different layers indicated in hierarchy information by causal discovery, the hierarchy information indicating a layer to which each of the elements belongs is given to each of the plurality of elements; and
generate the hypothesis model hierarchized in layer units indicated in the hierarchy information.

16. The information processing device according to claim 1, wherein the at least one processor is further configured to execute the instructions to:
display a graph representing the hypothesis model as a node and a path and an object for threshold designation that receives designation of a threshold of a path coefficient;
display a path having a path coefficient equal to or more than a threshold designated by the object for threshold designation and a node that is a starting point of the path; and
not display a path having a path coefficient less than the threshold and a node that is a starting point of the path.

17. The information processing device according to claim 1,
wherein the at least one processor is further configured to execute the instructions to:
display a causal graph indicating a causal relationship between the plurality of observation variables;
receive designation by an operator;
classify the observation variables into a plurality of groups according to the designation; and
set a latent factor related to each of the groups.

18. A model generation method comprising:
by at least one processor,
inferring a relationship between a plurality of elements including a latent factor associated with a plurality of observation variables by causal discovery; and
generating a hypothesis model for covariance structure analysis from the plurality of elements, based on a result of the inference.

19. A non-transitory recording medium recording a program for causing a computer to execute:
inferring a relationship between a plurality of elements including a latent factor associated with a plurality of observation variables by causal discovery; and
generating a hypothesis model for covariance structure analysis from the plurality of elements, based on a result of the inference.
